(19) United States
(12) Patent Application Publication
(10) Pub. No.: US 2022/0284419 A1
(43) Pub. Date: Sep. 8, 2022

(54) SYSTEMS AND METHODS FOR AUTOMATIC ASSET TRANSFER USING SMART CONTRACTS

(71) Applicant: DISH Wireless L.L.C., Englewood, CO (US)

(72) Inventors: Evan Tedesco, Highlands Ranch, CO (US); Christopher Ergen, Littleton, CO (US)

(21) Appl. No.: 17/193,416

(22) Filed: Mar. 5, 2021

(51) Int. Cl. G06Q 20/36; H04L 9/06; G06Q 20/40; G06N 20/00; G06Q 40/06; G06Q 40/02

(52) U.S. Cl. CPC G06Q 20/3678; H04L 9/0643; G06Q 20/401; G06N 20/00; G06Q 40/06; G06Q 40/02; H04L 2209/38

(57) ABSTRACT

Examples of the present disclosure describe systems and methods for automatically transferring assets based on a smart contract. In one example, a smart contract is constructed between a consumer and a service provider. The smart contract is stored on a blockchain. Financial data associated with the consumer may be received by the system, and based on the financial data associated with the consumer, the system may construct an investment profile for the consumer. The system may receive a deposit of assets (e.g., cryptocurrency). The funds may be placed into an escrow wallet, where the funds may be drawn upon based on the rules of the smart contract. At least a portion of the funds may also be automatically invested based on the investment profile of the consumer. The system may receive a trigger event, which may cause a transfer of assets from the escrow wallet to the service-provider wallet.

### TECHNICAL FIELD

The present disclosure relates to the fields of payment protocols, smart contracts, and blockchain systems.

### BACKGROUND

Present day payments infrastructures for subscription-based services usually requires a user to pay a service provider on a monthly or annual basis, regardless of use of that service. For example, in most utility contexts (such as Internet), a user will pay a flat rate to an Internet Service Provider (ISP) per month, regardless of how much the user actually uses the Internet or regardless of the amount of time the Internet is inaccessible due to down time and outages. These service contracts between the service provider and the user are bulky and inefficient. They also do not consider the amount of use of a service during a time period. As such, there is a need to more efficiently and transparently transfer assets between a user and a service provider based on use of a service.

One facet of the present application is blockchain-based technology. A blockchain is a continuously growing list of records, called blocks, which are linked and secured using cryptography. Each block may contain a hash pointer as a link to a previous block, a timestamp, and transactional data (e.g., each block may include many transactions). By design, a blockchain is inherently resistant to modification of the transactional data. A blockchain may be managed by a peer-to-peer network of nodes (e.g., devices) collectively adhering to a consensus protocol for validating new blocks. Once recorded, the transaction data in a given block cannot be altered retroactively without the alteration of all previous blocks, which requires collusion of a majority of the network nodes.

A blockchain is an append-only data structure maintained by a network of nodes that do not fully trust each other. A permissioned blockchain is a type of blockchain where access to the network of nodes is controlled in some manner, e.g., by a central authority and/or other nodes of the network. All nodes in a blockchain network agree on an ordered set of blocks, and each block may contain one or more transactions. Thus, a blockchain may be viewed as a log of ordered transactions. One particular type of blockchain (e.g., Bitcoin) stores coins as system states shared by all nodes of the network. Bitcoin-based nodes implement a simple replicated state machine model that moves coins from one node address to another node address, where each node may include many addresses.

Furthermore, public blockchains may include full nodes, where a full node may include an entire transactional history (e.g., a log of transactions), and a node may not include the entire transactional history. For example, Bitcoin includes thousands of full nodes in all of the nodes that are connected to Bitcoin.

With the advent of decentralized blockchains came decentralized finance, or “DeFi.” DeFi is an umbrella term for centralized permissionless financial infrastructure, wherein a variety of cryptocurrency-based financial applications operate. What makes these applications decentralized is that they are not managed by a central institution, but instead, the rules of these applications are written in code, and the code is open to the public for anyone to audit. These rules written in code are known as “smart contracts,” which are programs running on a blockchain that execute automatically when certain conditions are met. DeFi applications are built using smart contracts. DeFi applications can be viewed as a cluster of second layer applications running on top of a blockchain.

Another concept related to DeFi and blockchain technology is “stablecoins.” A stablecoin is a class of cryptocurrencies that attempts to offer price stability and is backed by a reserve asset. Stablecoins typically peg their value to some “stable” external reference, such as a fiat currency like the U.S. dollar or a commodity's price, such as gold. These stablecoins can be collateralized or non-collateralized. Collateralized stablecoins are often backed by commodities, fiat, or cryptocurrency. For example, a popular stable coin, DAI, is collateralized with cryptocurrency (Ether) but pegged to the U.S. dollar. Non-collateralized stablecoins, on the other hand, do not use any reserve but instead use algorithms or other consensus mechanisms to increase or decrease the supply of stablecoins based on supply and demand.

Presently, many payments infrastructures lack security and transparency. For instance, in the context of service-based/subscription contracts, payments are fixed regardless of up or down time of that service. The user typically does not have access to a report detailing the use of the service and is therefore prevented from understanding whether the user is paying a fair price for the service received. Additionally, if a user overpays for a service or is accidentally charged for use of a service, the user must typically engage with a financial intermediary to attempt to have the payment returned. This process is usually cumbersome and time-consuming, as well as technologically inefficient. Furthermore, there are technological barriers to receiving payment from a user if a user's payment method fails (e.g., closed bank account, switched credit cards, etc.). In order to recoup cost of a service, the service provider typically has to interface with a financial intermediary in order to obtain payment or resort to collection agencies. Such processes are inefficient and cumbersome for the service provider. As such, there is an increased need to more securely, efficiently, and transparently transfer assets between a user of a service and a service provider.

It is with respect to these and other general considerations that the aspects disclosed herein have been made. Also, although relatively specific problems may be discussed, it should be understood that the examples should not be limited to solving the specific problems identified in the background or elsewhere in the disclosure.

### BRIEF DESCRIPTION OF THE DRAWINGS

Non-limiting and non-exhaustive examples are described with reference to the following figures.

FIG. 1 illustrates an example of a distributed system for automatically transferring assets based on a smart contract.

FIG. 2 illustrates an example distributed blockchain architecture for automatically transferring assets based on a smart contract.

FIG. 3 illustrates an example input processing system for implementing systems and methods for automatically transferring assets based on a smart contract.

FIG. 4 illustrates an example method for automatically transferring assets based on a smart contract.

FIG. 5 illustrates an example asset transfer involving a service provider, consumer, blockchain, and DeFi application(s).

FIG. 6 illustrates one example of a suitable operating environment in which one or more of the present embodiments may be implemented.

### DETAILED DESCRIPTION

Various aspects of the disclosure are described more fully below with reference to the accompanying drawings, which form a part hereof, and which show specific exemplary aspects. However, different aspects of the disclosure may be implemented in many different forms and should not be construed as limited to the aspects set forth herein; rather, these aspects are provided so that this disclosure will be thorough and complete, and will fully convey the scope of the aspects to those skilled in the art. Aspects may be practiced as methods, systems, or devices. Accordingly, aspects may take the form of a hardware implementation, an entirely software implementation or an implementation combining software and hardware aspects. The following detailed description is, therefore, not to be taken in a limiting sense.

Embodiments of the present application are directed to systems and methods for automatically transferring assets based on smart contracts. Specifically, the present application is directed to smart contracts between a consumer and a service provider that allows the service provider to collect automatic payments via a smart contract based on the use of the service by the consumer. Additionally, the architecture that allows for this pay-per-use (or pay-per-bit) model utilizes escrowed funds to pay the service provider and to invest the leftover. In one example, a consumer may make a deposit of a cryptocurrency, such as a stablecoin, via DeFi application on a blockchain. The crypto deposit may be held in escrow (e.g., the smart contract may be an escrow mechanism). Based on at least one smart contract between the consumer and the service provider, funds are drawn out of escrow on a predetermined schedule based on a consumer's use of the service. Simultaneously, while the funds are placed in escrow, the systems described herein may automatically transfer the escrowed funds into investments to earn interest on the escrowed funds. Such investments may be executed according to a consumer's investment profile (e.g., low-risk, high-risk, crypto-focused, securities-focused, etc.). The investment strategy of the escrowed funds may be based on at least one machine-learning model that considers the consumer's profile, as well as similarly-situated consumers.

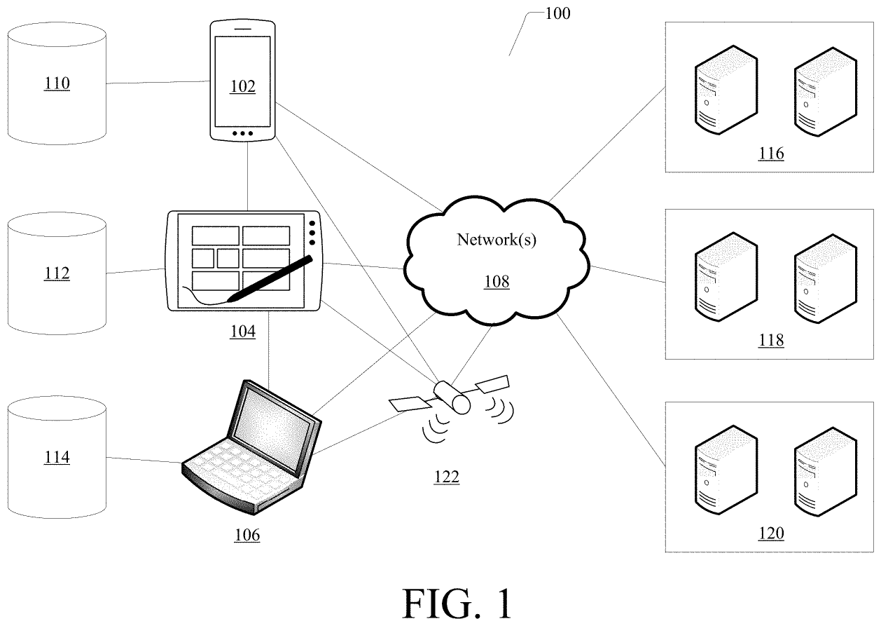

FIG. 1 illustrates an example of a distributed system for automatically transferring assets based on a smart contract. Example system 100 presented is a combination of interdependent components that interact to form an integrated whole for automatically transferring an asset based on a smart contract. Components of the systems may be hardware components or software implemented on, and/or executed by, hardware components of the systems. For example, system 100 comprises client devices 102, 104, and 106, local databases 110, 112, and 114, network(s) 108, and server devices 116, 118, and/or 120.

Client devices 102, 104, and/or 106 may be configured to receive and transmit cryptocurrency assets, such as stablecoins. They may also be configured to communicate within a blockchain network, as well as host a copy of a blockchain locally in local databases 110, 112, and/or 114. On top of the blockchain may reside a DeFi application that the client devices 102, 104, and/or 106 are configured to run (and/or interact with). In one example, a client device 102 may be a mobile phone, client device 104 may be a tablet, and client device 106 may be a laptop/personal computer. Other possible client devices include but are not limited to set-top boxes, Over-the-Air antennas, televisions (e.g., smart televisions), etc.

In some example aspects, client devices 102, 104, and/or 106 may be configured to communicate with a satellite, such as satellite 122. Satellite 122 may be a satellite (or multiple satellites) within a cellular system. Client devices 102, 104, and/or 106 may receive data via cellular protocols from satellite 122. The cellular data received by client devices 102, 104, and/or 106 may be stored local databases 110, 112, and/or 114. Additionally, such cellular data may be stored remotely at remote servers 116, 118, and/or 120. In other examples, client devices 102, 104, and/or 106 may be configured to communicate with one another via near-range communication protocols, such as Bluetooth.

Client devices 102, 104, and/or 106 may also be configured to run software that implements (and//or interacts with) a blockchain with at least one DeFi application for automatically transferring assets to service providers and investment vehicles from an escrow account (e.g., smart contract). Furthermore, client devices 102, 104, and/or 106 may be configured to run software that constructs an investment profile and stores the investment profile on the blockchain. For instance, construction of an investment profile may depend on information gathered from information already stored on at least one blockchain and/or other traditional stores of information, such as a database. Additionally, the investment profile may comprise cryptographic keys that may be used to access/decrypt the profile on the blockchain.

For example, during initial setup, the consumer may provide certain information to the system via client device(s) 102, 104, and/or 106. The system may process that information to construct an investment profile. The investment profile may be stored remotely on server(s) 116, 118, and/or 120, and/or locally at databases 110, 112, and/or 114. The investment profile may be stored as a block on the blockchain. A consumer may initiate a transfer of assets from a client device over network(s) 108 or satellite 122. The assets may be transferred via a DeFi application operating on a blockchain. The assets may first be stored in escrow (e.g., as a block on a blockchain).

A smart contract may also reside on the blockchain network. Copies of the smart contract may be stored locally at local databases 110, 112, and/or 114, as well as remotely at servers 116, 118, and/or 120. The smart contract may determine how the escrowed assets are transferred and to which entity. For example, the smart contract may be a smart contract between a consumer and a service provider. Based on a usage basis, new transactions may be appended to the blockchain based on certain conditions being met on the smart contract. For example, for every gigabyte of data that is utilized from a consumer's Internet service, a certain amount of assets are transferred from the escrow wallet to the service-provider wallet. In other instances, the smart contract could be time-based: for every minute of use of the service, assets are transferred from the escrow wallet to the service-provider wallet. The transaction may be recorded as a block on the blockchain.

Additionally, the escrowed assets may be automatically invested in certain investment vehicles, such as other cryptocurrencies, securities, and/or interest-bearing instruments (e.g., loans). Such transactions may also be recorded as blocks on the blockchain. The investment strategy may be automatically executed based on a consumer's investment profile and at least one machine-learning model. At least one database of investment options and similarly-situated consumers may be accessed by client device(s) 102, 104, and/or 106 via network(s) 108 and/or satellite 122. The database(s) may also be stored locally at database(s) !10, 112, and/or 114.

In some example aspects, client devices 102, 104, and/or 106 may be equipped to receive signals from an input device. Signals may be received on client devices 102, 104, and/or 106 via Bluetooth, Wi-Fi, infrared, light signals, binary, among other mediums and protocols for transmitting/receiving signals. For example, a user may use a mobile device 102 to query a blockchain to receive an update on the current usage of a service or an asset balance in the escrow account, or a portfolio of investments. A graphical user interface may display on the mobile device 102 indicating the asset allocation information associated with the escrow account.

In other example aspects, devices 116, 118, and/or 120 may be databases that are utilized to construct an investment profile for a consumer. For instance, one database may comprise historical investment information associated with similarly-situated consumers. Another database may comprise individual consumer information based on information received from financial accounts, social media profiles, credit reports, etc. In another example, a database may comprise investment analyses on various investment vehicles. Specifically, one database may match potential borrowers and lenders based on loan terms, amount desired, lender risk tolerance, and creditworthiness of borrower, among other factors. While the assets of a consumer are held in an escrow account on a blockchain, the assets may be transferred via a second layer DeFi application as a loan, whereby the consumer may earn interest on those assets while they are in escrow. When it comes time to remit payment to a service provider based on the terms of a smart contract, the loan may be called and used to pay the service provider, or, alternatively, the interest earned on the loan may be sufficient to pay the service provider. Such a payments infrastructure using blockchain technology and DeFi applications improves security and transparency of service-provider contracts, as well as improves the technological process of transmitting and receiving payments for services.

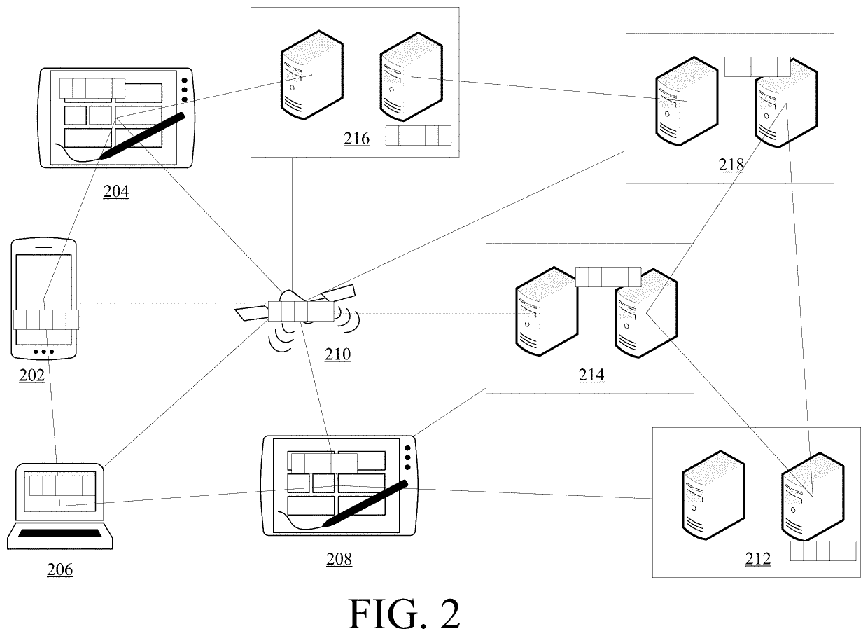

FIG. 2 illustrates an example distributed blockchain architecture for automatically transferring assets based on a smart contract. FIG. 2 is an alternative illustration of a distributed system like FIG. 1. In FIG. 2, each of the network devices are interconnected and communicate with one another. Each device in the network has a copy of the blockchain (or at least a partial copy of the blockchain, e.g., light nodes), as the blockchain is not controlled by any single entity but rather a distributed system, in some examples. In other examples, the blockchain may be a permissioned blockchain that includes an access-control layer, preventing and allowing some devices to read and write certain information to the blockchain.

Specifically, in FIG. 2, mobile device 202, tablets 204 and 208, laptop 206, satellite 210, and server nodes 212-218 are all connected and communicating with one each other in the blockchain network. Each node may store a local copy of the blockchain, or at least a portion of the blockchain. For example, laptop 206 may query the blockchain in the blockchain network, and server 214 may receive the query and produce a block from the copy of the blockchain that is stored on server 214. Laptop 206 may receive the information located within the block (e.g., asset balance, smart contract rules, etc.). In short, the systems and methods described herein may be implemented within a distributed architecture as displayed in FIG. 2, and in some examples, implemented on a single node within the distributed blockchain network.

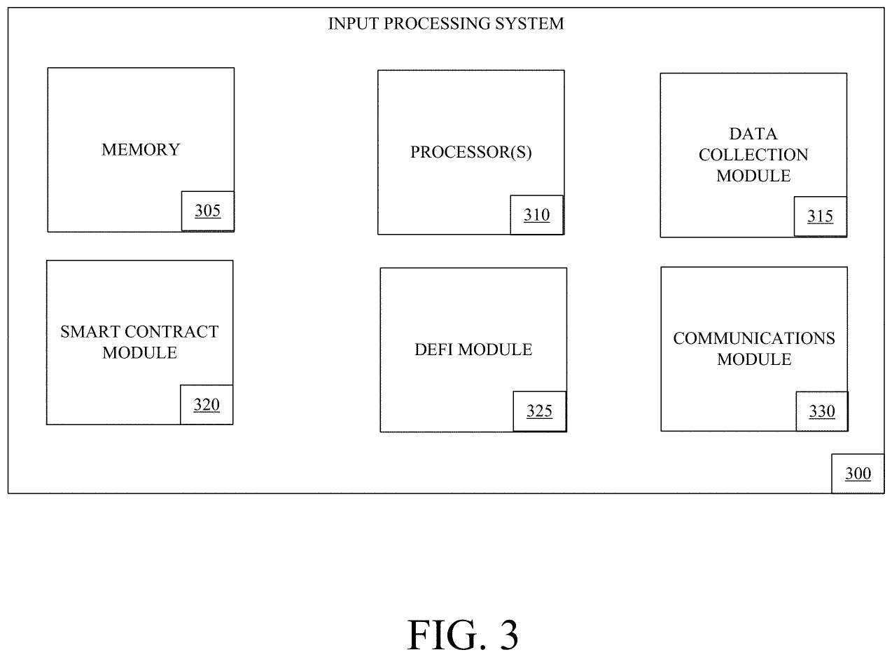

FIG. 3 illustrates an example input processing system for implementing systems and methods for automatically transferring assets based on a smart contract. The input processing system (e.g., one or more data processors) is capable of executing algorithms, software routines, and/or instructions based on processing data provided by a variety of sources related to verifying a device location. The input processing system can be a general-purpose computer or a dedicated, special-purpose computer. According to the embodiments shown in FIG. 3, the disclosed system can include memory 305, one or more processors 310, data collection module 315, smart contract module 320, DeFi module 325, and communications module 330. Other embodiments of the present technology may include some, all, or none of these modules and components, along with other modules, applications, data, and/or components. Still yet, some embodiments may incorporate two or more of these modules and components into a single module and/or associate a portion of the functionality of one or more of these modules with a different module.

Memory 305 can store instructions for running one or more applications or modules on processor(s) 310. For example, memory 305 could be used in one or more embodiments to house all or some of the instructions needed to execute the functionality of data collection module 315, smart contract module 320, DeFi module 325, and communications module 330. Generally, memory 305 can include any device, mechanism, or populated data structure used for storing information, including a local copy of a blockchain data structure. In accordance with some embodiments of the present disclosures, memory 305 can encompass, but is not limited to, any type of volatile memory, nonvolatile memory, and dynamic memory. For example, memory 305 can be random access memory, memory storage devices, optical memory devices, magnetic media, floppy disks, magnetic tapes, hard drives, SIMMs, SDRAM, RDRAM, DDR, RAM, SODIMMs, EPROMs, EEPROMs, compact discs, DVDs, and/or the like. In accordance with some embodiments, memory 305 may include one or more disk drives, flash drives, one or more databases, one or more tables, one or more files, local cache memories, processor cache memories, relational databases, flat databases, and/or the like. In addition, those of ordinary skill in the art will appreciate many additional devices and techniques for storing information that can be used as memory 305. In some example aspects, memory 305 may store at least one database containing historical investment data related to a consumer profile, similarly-situated consumer investment data, investment vehicle analyses, etc. In other examples aspects, memory 305 may store at least one copy of a blockchain with at least one DeFi application running on the blockchain. In yet other example aspects, memory 305 may store assets (e.g., stablecoins) that may be submitted to a blockchain via a DeFi application. In other aspects, memory 305 may be configured to store at least one investment profile and/or investment strategy to invest escrowed assets. Any of the data, programs, and databases that may be stored in memory 305 may be applied to data collected by data collection module 315.

Data collection module 315 may be configured to collect data associated with at least one consumer's investment profile. For instance, data collection module 315 may be configured to receive data associated with a consumer's financial history, financial accounts, credit reports, social media profiles, and the like. Such information may be received by data collection module 315 through client devices and/or trusted third-party sources. Data collection module 315 may also be configured to query at least one database associated with historical investment data associated with similarly-situated consumers as the consumer involved in the smart contract transaction with the service provider. The historical investment data may comprise historical trends of successful and unsuccessful investments from past consumers based on a consumer's investment profile, including risk tolerance. Data collection module 315 may also be configured to receive real-time updates regarding an asset balance in an escrow wallet. For instance, after a consumer deposits assets on the blockchain, the asset balance will be established. When assets are transferred from the escrow wallet to a service provider wallet, a new balance is reflected that may be captured by data collection module 315. Similarly, when assets are transferred to investment vehicles (e.g., loaned out via a DeFi lending application), the information associated with the loan (e.g., borrower, interest rate, payment schedule, etc.) may be received by data collection module 315.

Alternately, data collection module 315 may interrogate, or otherwise solicit data from, one or more data sources comprising such information (e.g., other nodes in a network). For example, data collection module 315 may have access to data in one or more external systems, such as content systems, distribution systems, marketing systems, user profiles or preference settings, authentication/authorization systems, device manifests, or the like. Specifically, data collection module 315 may have access to at least one database of historical investment data and up-to-date investment analyses (e.g., analyses regarding cryptocurrencies, securities, real property, lending, litigation finance, etc.), which may inform the system as to which investment strategy may be most compatible based on the consumer's investment profile. Data collection module 315 may use a set of APIs or similar interfaces to communicate requests to, and receive response data from, such data sources. In at least one example, the data collection process of data collection module 315 may be triggered according to a preset schedule, in response to a specific user request to collect data (e.g., user wants to know balance of escrow wallet), or in response to the satisfaction of one or more criteria (e.g., investment strategy is rebalanced based on incoming new financial information associated with the consumer). Data collection module 315 may also receive information from devices such as OTA boxes, set-top boxes, smart antennas (e.g., smart OTA antenna), televisions, smart televisions, and the like, which may include media content viewing history (which may inform the system described herein of the investment risk tolerance of the consumer).

Data collection module 315 may also be configured to receive data from service providers regarding service-provider contract terms. Such terms may be stored in data collection module 315 and passed to smart contract module 320 for construction of a smart contract.

Smart contract module 320 may be configured to receive data from data collection module 315. The data received by smart contract module 320 may allow the smart contract module 320 to construct at least one smart contract between a consumer and a service provider. For example, data received by the smart contract module 320 may be contract terms (i.e., rules) that the service provider requires for a service contract between the consumer and service provider. Specifically, a certain contract term may require that a certain amount of stablecoins be transferred to a service provider wallet address per 1 gigabyte of use of the service by the consumer. In examples, the smart contract (operating via a DeFi application on top of a blockchain) may have access to a third-party application monitoring the use of a service by the consumer. Based on the information received from the use monitor application, asset transfer can be triggered automatically.

In another example, the smart contract module 320 may be configured to trigger the transfer of funds from an escrow wallet to a service provider wallet and vice versa. For instance, when a service is down, a smart contract rule may require that a certain amount of assets (e.g., stablecoins) be transferred from a service provider wallet address to a consumer wallet address.

In yet another example, smart contract module 320 may be configured to interact with DeFi module 325, wherein the smart contract module 320 may create rules that trigger a transfer of assets from an investment account (on the blockchain) associated with the consumer to a service provider wallet address. For instance, certain escrowed assets of a consumer may be invested via DeFi module 325. An action occurs that prompts the smart contract module 320 to initiate a transfer of assets from the escrow wallet address to the service provider address. However, the smart contract module 320 notices that there are insufficient liquid assets in the escrow wallet, so the smart contract module 320 then queries the DeFi module 325 to check if some assets are presently tied up in investment vehicles. If the assets are invested, then one potential rule within the smart contract may trigger a sale of investments via the DeFi module 325 so that the assets can be freed up for transfer from the escrow wallet to the service provider wallet. If assets are not invested, then the smart contract module 320 may determine that the consumer has insufficient funds to continue sustaining the service, and such a determination may trigger the shutting-off or downgrading of the service provided to the consumer.

DeFi module 325 may be configured to automatically invest escrowed assets, such as stablecoins. The objective of the automatic investment may be to earn interest on the assets stored in escrow while they await transfer to a service provider wallet based on the consumer's use of the service. Rather than having the funds sit inactively, the DeFi module 325 may automatically allocate the funds to certain investment vehicles, such as other cryptocurrencies, securities, loans, etc. Such a determination may be made according to a consumer's investment profile, which may be received from data collection module 315.

In one example, DeFi module 325 may be configured to construct a consumer's investment profile. To construct a consumer's investment profile, DeFi module 325 may use at least one pattern recognizer. The pattern recognizer within DeFi module 325 may be configured to identify and extract various investment-related features with the consumer that the De Fi module 325 receives from data collection module 315. Such data may include consumer financial records, financial history, credit reports, social media profiles, job histories, background checks, etc. Such features may then be provided to at least one machine-learning model, where the machine-learning model identifies a predicted risk tolerance and investment strategy for the consumer. The investment strategy output for DeFi module 325 may be, for example, a high risk or low risk profile. A high-risk profile may prompt the DeFi module 325 to establish automatic investments of the assets into higher-risk investments, such as higher-yield loans to riskier borrowers. Alternatively, a low-risk profile may prompt the DeFi module 325 to establish automatic investments of the assets into lower-risk investments, such as lower-yield loans to low-risk, accredited borrowers. In other examples, the investment strategy may be to invest in higher or lower risk cryptocurrencies based on the investment strategy output provided to DeFi module 325.

In some aspects, the pattern recognizer within DeFi module 325 may have two modes: a training mode and a processing mode. During the training mode, the pattern recognizer may use the identified investment profile features to train one or more ML models. Once the one or more ML models are trained, the pattern recognizer may enter processing mode, where input data is compared against the trained ML models in the pattern recognizer. The pattern recognizer may then produce a confidence score that denotes the confidence of certain consumer investment features appearing in the input data, with a high confidence score being associated with a higher likelihood of recommending a particular investment strategy for the DeFi module 325 to deploy for the consumer. In other aspects, during training mode, pattern recognizer may use different types of investment features from similarly-situated consumers and historical investment analyses to train one or more ML models to distinguish between certain data points that support one investment strategy over an alternative strategy. For instance, a low liquidity indicator (i.e., not a lot of liquid assets in a checking account) for a consumer may suggest a lower-risk investment strategy, whereas a high liquidity indicator may suggest a more higher risk investment strategy, since the consumer may be able to cover any potential losses from the higher-risk investments and continue satisfying the underlying smart contract with the service provider.

DeFi module 325 may be configured with at least one machine learning model. In some aspects, the extracted investment features from consumer data collected by data collection module 315 may be used to train at least one machine learning model associated with the pattern recognizer during training mode. For example, to train the machine learning model, the extracted and identified investment features may be associated with specific risk identifiers, such as job history, projected income, credit worthiness, social media profile activity (e.g., topics of interest, posts, likes, pictures, comments), etc. The pattern recognizer of DeFi module 325 may utilize various machine learning algorithms to train the machine learning model, including but not limited to linear regression, logistic regression, linear discriminant analysis, classification and regression trees, naïve Bayes, k-Nearest neighbors, learning vector quantization, neural networks, support vector machines (SVM), bagging and random forest, and/or boosting and AdaBoost, among other machine learning algorithms. The aforementioned machine learning algorithms may also be applied when comparing input data to an already-trained machine learning model. Based on the identified and extracted investment features and patterns, pattern recognizer may select the appropriate machine learning algorithm to apply to the investment features to train the at least one machine learning model. For example, if the investment features are complex and demonstrate non-linear relationships, then the pattern recognizer may select a bagging and random forest algorithm to train the machine learning model. However, if the investment features demonstrate a linear relationship to certain risk profiles, then pattern recognizer may apply a linear or logistic regression algorithm to train the machine learning model.

In other aspects, DeFi module 325 may apply at least one already-trained machine learning model to the received investment features and patterns to detect previously identified and extracted financial information associated with the consumer and previously recognized patterns. The pattern recognizer may be configured to compare at least one trained machine learning model to the investment features to generate comparison results that indicate whether the investment features contain certain risk indicators. Specifically, the pattern recognizer may compare the identified and extracted investment features to at least one model trained on previously received investment features that are associated with similarly-situated consumers. The pattern recognizer may also be configured to generate comparison results, indicating the similarity (or lack thereof) between certain investment features on which the machine learning model was trained and the investment features received from data collection module 315. In other aspects, the comparison results may include an investment feature confidence indicator that a certain investment feature indicates a certain level of risk and/or suggests a particular investment strategy. For instance, the comparison results may generate an investment strategy confidence indicator that a specific risk indicator is present in the investment features and/or patterns. The comparison results may include investment strategy confidence indicator information regarding identified high-risk and low-risk indicators in the received financial data associated with the consumer. The investment strategy confidence information may then be used in determining the overall investment strategy for the consumer for the escrowed assets.

Communications module 330 is associated with sending/receiving information (e.g., collected by data collection module 315, smart contract module 320, and DeFi module 325) with a remote server or with one or more client devices, streaming devices, servers, OTA boxes, set-top boxes, smart televisions, etc. These communications can employ any suitable type of technology, such as Bluetooth, WiFi, WiMax, cellular, single hop communication, multi-hop communication, Dedicated Short Range Communications (DSRC), or a proprietary communication protocol. In some embodiments, communications module 330 sends information collected by data collection module 315 and processed by smart contract module 320 and DeFi module 325. Furthermore, communications module 330 may be configured to communicate certain terms of a smart contract from smart contract module 320 and an automatic investment strategy based on DeFi module 325 to a client device. Additionally, communications module 330 may be configured to communicate an updated balance to a client device after certain assets were transferred, e.g., from an escrow wallet to a service provider wallet.

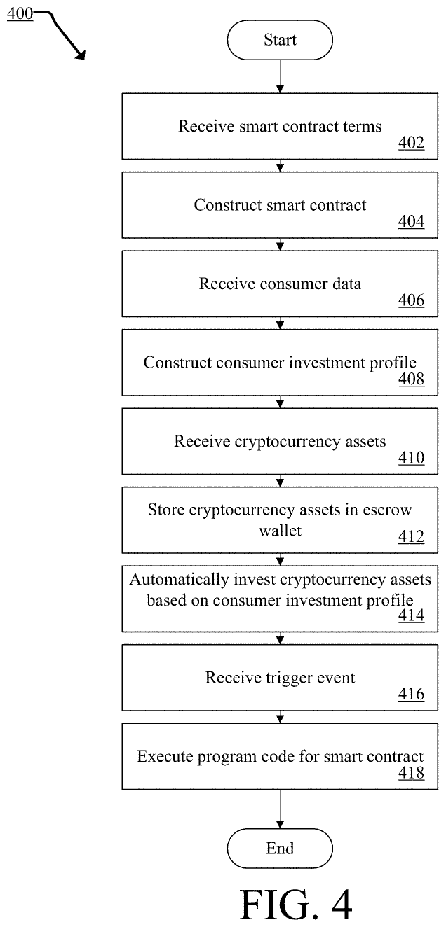

FIG. 4 illustrates an example method for automatically transferring assets based on a smart contract. Method 400 begins with step 402, receive smart contract terms. At step 402, the system may receive terms of a certain contract, such as a service-provider contract. The terms may specify the price a consumer must pay to use the service. In some examples, the smart contract terms may be based on pay-per-bit or pay-per-time. Because the terms of the service-provider will be captured as a smart contract on a blockchain, an ongoing pay-per-use structure is feasible because the smart contract is self-executing. In a standard contract, if the payment structure was set up as a pay-per-use structure, then the remitting of payments and manual monitoring of services would have to occur as frequently as the terms specified. Even daily monitoring of such a manual contract would be infeasible and cumbersome for parties to execute. With a smart contract, however, the terms can be self-executing as frequently as the parties would like. For example, every 60 seconds, the system could monitor the use of the service by the consumer and, based on the amount of use, transfer assets from an escrow wallet (representing the assets deposited by the consumer) to a service provider wallet. No intermediaries (e.g., banks, financial institutions) are required.

Once the smart contract terms are received by the system at step 402, the smart contract may be constructed at step 404. Here, the smart contract may be automatically deployed on the blockchain according to the specified rules agreed to between the service provider and the consumer.

The system may also receive consumer data at step 406. The consumer data received by the system at step 406 may represent the previously explained investment feature data that may be obtained from a consumer's financial reports, bank accounts, credit reports, background checks, social media profiles, questionnaire answers, etc. Once the system receives the consumer data at step 406, the consumer data may be used by the system to construct a consumer investment profile at step 408. The consumer investment profile may be used by the system to automatically invest escrowed funds that are not presently being transmitted to a service provider based on the underlying terms of the smart contract. For example, a user may deposit 100 stablecoins to an escrow wallet. The smart contract may begin triggering transfers of the assets to the service provider wallet based on the consumer's use of the service. In one instance, the average transfer may be 0.50 stablecoins per day to the service provider wallet. As such, over the course of 30 days, only 15 of the 100 stablecoins will be used to pay for the service. During the course of those 30 days, the system may automatically invest the remainder of the stablecoins into yield-bearing financial vehicles, such as loans, cryptocurrencies, securities, etc. In one example, the system may invest 75 of the 100 stablecoins (i.e., 15 stablecoins are used to pay the service provider over the course of a month, 10 stablecoins are left in the escrow wallet uninvested as “emergency” reserve in case use of the service spikes, and the remaining 75 stablecoins are invested). Based on the investment profile of the consumer, the system may automatically invest the 75 stablecoins into a loan with a 10% monthly interest rate. After 30 days have passed, the consumer will have an additional 7.5 stablecoins from the automatic investment. This yield may then be transmitted back to the escrow wallet to use to pay for future service use according to the terms of the smart contract (i.e., the 7.5 stablecoin return would pay, on average, for half a month of services from the service provider, in this example). In other examples, the yield could be exchanged for fiat currency and transferred back to the consumer in a checking account. In yet other examples, the yield could be reinvested according to the automatic investment strategy determined for the consumer based on the consumer's investment profile.

Once the consumer investment profile is constructed at step 408, the system may receive a deposit of assets at step 410. These assets may be in the form of cryptocurrency (e.g., Bitcoin, Ethereum, stablecoins, etc.). The assets may be stored in an escrow wallet at step 412, and the transaction may be recorded as a block on the blockchain. In other example aspects, steps 410 and 412 may consist of a consumer depositing funds in a smart contract (e.g., the smart contract may be an escrow mechanism itself).

After the assets are received and placed in an escrow wallet at steps 410 and 412, at least a predetermined portion of the assets may be invested. The investment of the assets may be automatic according to the consumer investment profile constructed in step 408. The automatic investments at step 414 may be determined according to at least one machine-learning algorithm applied to a consumer investment profile and at least one database of investment options, as well as historical investment data for similarly-situated consumers.

At step 416, a trigger event may be received. The trigger event may be a threshold of use for a service by the consumer. For instance, a threshold may be a certain amount of data used (e.g., for every 1 GB of data used, pay X stablecoins). In another instance, the threshold may be based on time using the service (e.g., for every 1 minute of use, pay X stablecoins). Other examples of triggering events may include partial payment for services received by a user/subscriber. For instance, the smart contract terms may describe a scenario in which a user partially uses a service (e.g., streams Internet television service on weekends only), and the payment for use of the full service is reduced to a partial payment reflecting the actual use of the service by the user. In another example aspect, a triggering event at step 416 may involve cancelation of service, wherein assets that may be held in escrow by the user may be returned to the user's wallet upon receiving a cancelation indicator. Another triggering event at step 416 may involve a reward presented to the user for completing a separate task, such as signing up a new user to the service. When the system receives an indication that a new user signed up to the system and was referred to the service provider by the current user, then a reward may be triggered. The reward may be in the form of the service provider transmitting assets (e.g., cryptocurrency) to the user, the escrow wallet disbursing a portion of the funds back to the user, an increase in the type of service received by the user, etc.

In other example aspects, a user could configure a profile so that other wallets could be linked to the user wallet and the escrow wallet, wherein the third-party wallets may pay for the user's service (e.g., parents paying for child's service use, school paying for student's service use, etc.). In such a scenario, the transfer of assets among wallets may involve a third-party wallet that may transfer funds to an escrow wallet on behalf of the user.

Upon receiving the trigger event at 416, program code for the smart contract is executed at step 418, which may involve a transfer of assets from an escrow wallet to a service provider wallet. The transaction may also be recorded on the blockchain. In some examples, the program code for the smart contract at step 418 may also cause certain assets to be liquidated if they are invested. For instance, if a trigger event at step 416 causes the consumer to remit payment of a certain number of stablecoins to the service provider wallet, but the escrow wallet does not have sufficient assets because the assets are tied up in investments, then the program code at step 418 may cause the system to sell at least a portion of the investments to pay for the service according to the terms of the smart contract.

In the example where insufficient funds reside in the escrow wallet and investments, the system may transmit a notice to the consumer (e.g., via email, text message, notification, etc.), alerting the consumer that the balance is insufficient to continue using the service. If the consumer does not deposit more assets to the escrow wallet within a certain period of time, then the program code for the smart contract at step 418 may automatically shut off the service to the consumer.

The terms of the smart contract are self-executing, so the program code that is executed at step 418 is automatic and requires no human intervention or intermediary financial institutions.

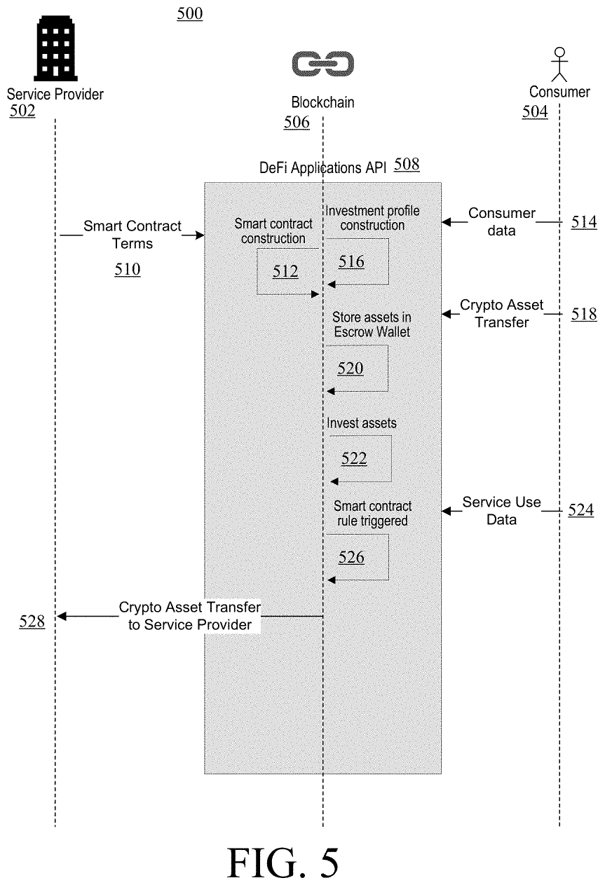

FIG. 5 illustrates an example asset transfer involving a service provider, consumer, blockchain, and DeFi application(s). Environment 500 illustrates the steps of method 400, as the transactions occur among the service provider 502, consumer 504, blockchain 506, and DeFi applications API 508. The service provider 502 may transmit smart contract terms 510 to the DeFi Applications API 508, which is running on top of the blockchain 506. In other instances, the smart contract terms 510 may be negotiated between the service provider 502 and the consumer 504, so smart contract terms 510 may be received by the DeFi API 508 from consumer 504, in some examples. Once the smart contract terms 510 are agreed upon by the service provider 502 and the consumer 504, a smart contract may be constructed at 512, and the smart contract may be deployed on the blockchain. Once active, the code of the smart contract may be publicly available or, at least, available to those who have permission to read the blockchain (e.g., in a permissioned blockchain environment).

Similarly, consumer data 514 may be transmitted from the consumer to the DeFi API 508, where the DeFi applications may receive the consumer data and process the data to construct an investment profile at 516. As previously described, the investment profile construction 516 may utilize at least one machine-learning model that is applied to the consumer data, as well as historical investment data regarding similarly-situated consumers. Once the investment profile is constructed, it may be written to the blockchain 506. In some examples, the investment profile may be secured by an access control layer to protect the consumer's privacy.

The consumer may transmit cryptocurrency assets to the DeFi application API 508 at 518. These assets may be received by the DeFi API and stored in an escrow wallet, where the transaction from the consumer to the escrow wallet is stored on the blockchain at 520. In other aspects, the smart contract may serve as an escrow mechanism itself.

At least one DeFi application operating on the blockchain 506 may utilize the constructed investment profile on the blockchain to invest a portion of the transferred cryptocurrency assets based on the investment profile of the consumer. The investments that are automatically placed may each be recorded as transactions on blockchain 506. For example, if one of the investments is a loan (e.g., part of the consumer's cryptocurrency assets are loaned out to a borrower at a certain interest rate), the terms of that loan may be recorded on the blockchain 506 (e.g., as a separate smart contract between the consumer-lender and the borrower). Each investment action taken by the system (e.g., DeFi application that is using the consumer investment profile to place automatic investments) may be recorded on blockchain 506.

At least one DeFi application operating on blockchain 506 may also receive consistent updates regarding the consumer's use of the service at 524. These updates allow the system to monitor the service use and compare the use against the terms of the smart contract. When the use reaches a certain threshold, for example, a smart contract rule may be triggered at 526, whereby assets are automatically transferred from an escrow wallet to the service provider wallet at 528. In some examples, the system may monitor the uptime of the service, and if the service is down for a period of time, the smart contract may automatically have provisions that reimburse the consumer. In other words, a smart contract rule may be triggered at 526, wherein assets are transferred from a service provider wallet to an escrow wallet for the consumer. Furthermore, if the escrow wallet has insufficient funds to pay for the service based on the service use data 524, then the smart contract rule that may be triggered at 526 may include shutting off the service to the consumer. When a smart contract rule is triggered, the subsequent transaction is recorded on the blockchain 506.

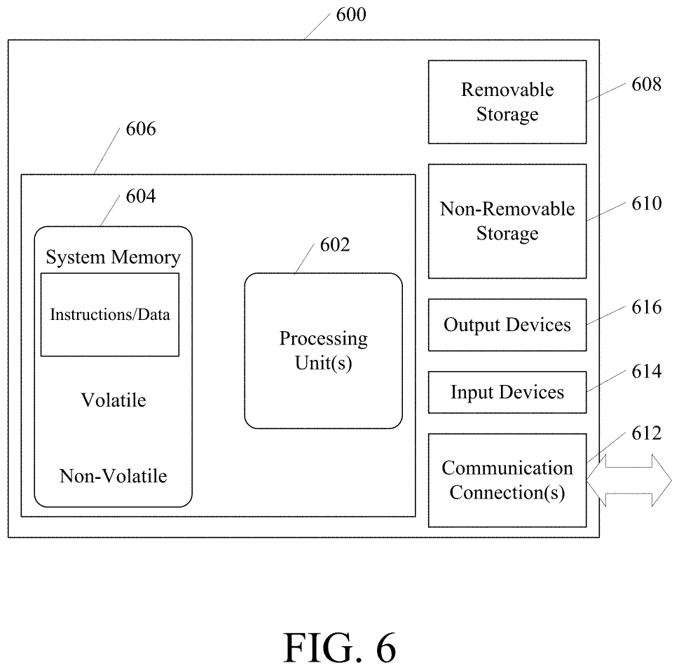

FIG. 6 illustrates one example of a suitable operating environment in which one or more of the present embodiments may be implemented. This is only one example of a suitable operating environment and is not intended to suggest any limitation as to the scope of use or functionality. Other well-known computing systems, environments, and/or configurations that may be suitable for use include, but are not limited to, personal computers, server computers, hand-held or laptop devices, multiprocessor systems, microprocessor-based systems, programmable consumer electronics such as smart phones, network PCs, minicomputers, mainframe computers, distributed computing environments that include any of the above systems or devices, and the like.

In its most basic configuration, operating environment 600 typically includes at least one processing unit 602 and memory 604. Depending on the exact configuration and type of computing device, memory 604 (storing, among other things, information related to devices, blockchain networks, payment settings, asset balances, DeFi investment strategies, and instructions to perform the methods disclosed herein) may be volatile (such as RAM), non-volatile (such as ROM, flash memory, etc.), or some combination of the two. This most basic configuration is illustrated in FIG. 6 by dashed line 606. Further, environment 600 may also include storage devices (removable 608 and/or non-removable 610) including, but not limited to, magnetic or optical disks or tape. Similarly, environment 600 may also have input device(s) 614 such as keyboard, mouse, pen, voice input, etc., and/or output device(s) 616 such as a display, speakers, printer, etc. Also included in the environment may be one or more communication connections, 612, such as Bluetooth, WiFi, WiMax, LAN, WAN, point to point, etc.

Operating environment 600 typically includes at least some form of computer readable media. Computer readable media can be any available media that can be accessed by processing unit 602 or other devices comprising the operating environment. By way of example, and not limitation, computer readable media may comprise computer storage media and communication media. Computer storage media includes volatile and nonvolatile, removable and non-removable media implemented in any method or technology for storage of information such as computer readable instructions, data structures (e.g., blockchains), program modules or other data. Computer storage media includes, RAM, ROM EEPROM, flash memory or other memory technology, CD-ROM, digital versatile disks (DVD) or other optical storage, magnetic cassettes, magnetic tape, magnetic disk storage, or other magnetic storage devices, or any other tangible medium which can be used to store the desired information. Computer storage media does not include communication media.

Communication media embodies computer readable instructions, data structures, program modules, or other data in a modulated data signal such as a carrier wave or other transport mechanism and includes any information delivery media. The term “modulate data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of any of the above should also be included within the scope of computer readable media.

The operating environment 600 may be a single computer (e.g., mobile computer) operating in a networked environment using logical connections to one or more remote computers. The remote computer may be a personal computer, a server, a router, a network PC, a peer device, an OTA antenna, a set-top box, or other common network node, and typically includes many or all of the elements described above as well as others not so mentioned. The logical connections may include any method supported by available communications media. Such networking environments are commonplace in offices, enterprise-wide computer networks, intranets, and the Internet.

Aspects of the present disclosure, for example, are described above with reference to block diagrams and/or operational illustrations of methods, systems, and computer program products according to aspects of the disclosure. The functions/acts noted in the blocks may occur out of the order as shown in any flowchart. For example, two blocks shown in succession may in fact be executed substantially concurrently or the blocks may sometimes be executed in the reverse order, depending upon the functionality/acts involved.

The description and illustration of one or more aspects provided in this application are not intended to limit or restrict the scope of the disclosure as claimed in any way. The aspects, examples, and details provided in this application are considered sufficient to convey possession and enable others to make and use the best mode of the claimed disclosure. The claimed disclosure should not be construed as being limited to any aspect, example, or detail provided in this application. Regardless of whether shown and described in combination or separately, the various features (both structural and methodological) are intended to be selectively included or omitted to produce an embodiment with a particular set of features. Having been provided with the description and illustration of the present application, one skilled in the art may envision variations, modifications, and the alternate aspects falling within the spirit of the broader aspects of the general inventive concept embodied in this application that do not depart from the broader scope of the claimed disclosure.

From the foregoing, it will be appreciated that specific embodiments of the invention have been described herein for purposes of illustration, but that various modifications may be made without deviating from the scope of the invention. Accordingly, the invention is not limited except as by the appended claims.

What is claimed is:

1. A system comprising:
at least one processor; and
memory coupled to the at least one processor, the memory comprising computer executable instructions that, when executed by the at least one processor, performs a method comprising:
receiving at least one contract term, wherein the at least one contract term is in the form of program code;
constructing, on a blockchain, at least one smart contract based on the at least one contract term;
receiving financial data associated with at least one consumer;
based on the financial data associated with the at least one consumer, constructing at least one consumer investment profile;
receiving a deposit of assets;
recording the deposit of assets on the blockchain;
storing the assets in at least one escrow wallet;
automatically transferring a portion of the assets to at least one investment vehicle based on the at least one consumer investment profile;
receiving at least one trigger event associated with the smart contract; and
in response to receiving the at least one trigger event, executing the at least one contract term.

2. The system of claim 1, wherein the at least one contract term comprises transferring a predetermined amount of assets from the at least one escrow wallet to at least one service-provider wallet.

3. The system of claim 2, the method further comprising:
recording, on the blockchain, a transfer of assets from the at least one escrow wallet to the at least one service-provider wallet.

4. The system of claim 1, wherein the financial data associated with the at least one consumer comprises at least one of: a financial report, a bank statement, a credit report, a social media profile, a response to a questionnaire, a background check, and a job history.

5. The system of claim 1, wherein constructing the at least one investment profile further comprises analyzing at least one database of historical financial data associated with consumers having similar investment profiles to the at least one consumer investment profile.

6. The system of claim 1, wherein constructing the at least one investment profile further comprises applying at least one machine-learning model to the financial data associated with the at least one consumer.

7. The system of claim 6, wherein the at least one machine-learning model is based in part on at least one of: a linear regression, a logistic regression, a linear discriminant analysis, a regression tree, a naïve Bayes algorithm, a k-nearest neighbors algorithm, a learning vector quantization, a neural network, a support vector machines (SVM), and a random forest algorithm.

8. The system of claim 6, the method further comprising:
training the at least one machine-learning model to distinguish between a high-risk consumer and a low-risk consumer.

9. The system of claim 1, wherein the at least one contract term is at least one of: a pay-per-use term and a pay-per-time term.

10. The system of claim 1, wherein the assets comprise at least one cryptocurrency coin.

11. The system of claim 10, wherein the at least one cryptocurrency coin is at least one of: a Bitcoin, an Ether, and a stablecoin.

12. The system of claim 1, wherein the at least one trigger event is an indication that usage of a service exceeded a predetermined threshold.

13. The system of claim 12, wherein the usage is measured based on at least one of: data and time.

14. The system of claim 1, wherein the at least one trigger event is an indication that a service is inoperable.

15. The system of claim 1, wherein the at least one trigger event is an indication that the at least one escrow wallet has insufficient funds.

16. A computer-implemented method for automatically transferring assets based on a smart contract comprising:
receiving at least one contract term, wherein the at least one contract term is in the form of program code;
constructing, on a blockchain, at least one smart contract based on the at least one contract term, wherein the at least one smart contract is between at least one consumer and at least one service provider;
receiving financial data associated with the at least one consumer;
based on the financial data associated with the at least one consumer, constructing at least one consumer investment profile;
receiving a deposit of cryptocurrency;
recording the deposit of cryptocurrency on the blockchain;
storing the cryptocurrency in at least one escrow wallet;
automatically transferring a portion of the cryptocurrency to at least one investment vehicle based on the at least one consumer investment profile;
receiving at least one trigger event associated with the smart contract; and
in response to receiving the at least one trigger event, executing the at least one contract term.

17. The method of claim 16, wherein the cryptocurrency comprises at least one of: a Bitcoin, an Ether, and a stablecoin.

18. The method of claim 16, wherein constructing the at least one consumer investment profile further comprises:
analyzing at least one database of historical financial data associated with consumers having similar investment profiles to the at least one consumer investment profile; and
applying at least one machine-learning model to the at least one consumer investment profile.

19. The method of claim 18, wherein the at least one machine-learning model is based on at least one of: a linear regression, a logistic regression, a linear discriminant analysis, a regression tree, a naïve Bayes algorithm, a k-nearest neighbors algorithm, a learning vector quantization, a neural network, a support vector machines (SVM), and a random forest algorithm.

20. A computer-readable media storing computer executable instructions that when executed cause a computing system to perform a method comprising:
receiving at least one contract term, wherein the at least one contract term is in the form of program code and wherein the at least one contract term specifies a transfer of assets from an escrow wallet to a service-provider wallet;
constructing, on a blockchain, at least one smart contract based on the at least one contract term, wherein the at least one smart contract is between at least one consumer and at least one service provider;
receiving financial data associated with the at least one consumer, wherein the financial data is at least one of: a financial record, a bank statement, a credit report, a background check, and a response to a questionnaire;
receiving financial data associated with at least one database of historical financial data;
based on the financial data associated with the at least one consumer and the financial data associated with the at least one database of historical financial data, constructing at least one consumer investment profile, wherein constructing at least one consumer investment profile further comprises applying at least one machine-learning model to the financial data associated with the at least one consumer;
receiving a deposit of at least one stablecoin;
recording the deposit of the at least one stablecoin on the blockchain;
storing the at least one stablecoin in the at least one escrow wallet;
automatically investing a first portion of the at least one stablecoin in at least one investment vehicle based on the at least one consumer investment profile;
receiving at least one trigger event associated with the smart contract;
in response to receiving the at least one trigger event, transferring a second portion of the at least one stablecoin to the at least one service-provider wallet; and
recording the transfer of the second portion of the at least one stablecoin to the at least one service-provider wallet on the blockchain.
